(19) United States
(12) Patent Application Publication
(10) Pub. No.: US 2010/0325009 A1
(43) Pub. Date: Dec. 23, 2010

(54) INTERNET AND MOBILE TECHNOLOGIES BASED SECURED LOTTERY SYSTEM AND METHOD

(75) Inventors: Selvan V. Rajan, Fremont, CA (US); NallaPerumal Subbian, Fremont, CA (US); Murthy Tanniru, Fremont, CA (US)

Correspondence Address: DLA PIPER LLP (US ), 2000 UNIVERSITY AVENUE, EAST PALO ALTO, CA, 94303-2248, US

(73) Assignee: mPura, Inc., Fremont, CA (US)

(21) Appl. No.: 12/816,776

(22) Filed: Jun. 16, 2010

Related U.S. Application Data
(60) Provisional application No. 61/187,733, filed on Jun. 17, 2009.

(51) Int. Cl. G06Q 30/00; H04L 9/32; G06F 21/00

(52) U.S. Cl. 705/26; 726/7

(57) ABSTRACT

A system and method for secure electronic government service are provided. The system and method can eliminate the need for travel to an authorized retailer by a player of the lottery since purchase can be facilitated anywhere, anytime via the Internet. In addition, using the system, winning tickets or games are automatically recognized and the purchaser is immediately notified and the winner will be notified using various electronics mechanisms and prize payments can be made in accordance with state law and the prize money will be automatically distributed to the winner's account. The system and method also can be used in similar applications like banking systems and voting systems where higher-level security standards, accountability of the purchaser and system transactions, and verification of those transactions are desirable.

### PRIORITY CLAIM/RELATED APPLICATION

This patent application claims the benefit under 35 USC 119(e) and priority under 35 USC 120 to U.S. Provisional Patent Application Ser. No. 61/187,733 filed on Jun. 17, 2009 and entitled “INTERNET AND MOBILE TECHNOLOGIES BASED SECURED LOTTERY SYSTEM AND METHOD”, the entirety of which is incorporated herein by reference.

### FIELD

The disclosure relates generally to a secured electronic government service system and method and in particular to a secured lottery system and method implemented using internet and mobile technologies.

### BACKGROUND

Currently, purchasers need to visit retail shops authorized by a state lottery to buy lottery or keno tickets or to play a game wherein the lottery may include keno. The need for intra and interstate travel to an authorized retailer is recognized as a reason for individuals not to purchase a ticket at all or to use an unauthorized reseller of lottery tickets for purchase by mail.

Winners do not get notified when they win and winning lottery tickets remain unclaimed as tickets are lost, destroyed, or forgotten. Furthermore, claiming the prize money needs another visit to the retail shop or to the lottery commission's nearby office.

State laws require the verification of the age of the purchaser of a lottery or keno ticket by either the retailer or the vending machine and no states have yet to utilize an Internet based online lottery and keno system because in part there is not yet a biometric means to verify the age and identity of the Internet purchaser. To play games like poker, roulette or similar games, the players need to go a physical location like casinos, or card game locations.

Thus, it is desirable to provide a secure lottery system and method that solves the limitations described above and it is to this end that the disclosure is directed.

### BRIEF DESCRIPTION OF THE DRAWINGS

FIGS. 1 and 2 illustrate a first embodiment of a secured lottery system and method;

FIGS. 3 and 4 illustrate another embodiment of the secured lottery system and method in which the user can play lottery games;

FIG. 5 illustrates the secured lottery system and method being used to distribute a prize to a user;

FIG. 6 illustrates the secured lottery system and method being used to store a game;

FIG. 7 illustrates the secured lottery system and method being used to view stored games;

FIG. 8 illustrates the secured lottery system and method being used to resolve a dispute;

FIG. 9 illustrates an example of the system configuration of the secured lottery system and method;

FIG. 10 illustrates the secured lottery system and method being used to secured process a payment;

FIG. 11 illustrates details of the security of the secured lottery system and method;

FIG. 12 illustrates an alternative embodiment of the secured lottery system and method in which the user can play lottery games; and

FIG. 13 illustrates an alternative way that the secured lottery system and method can be used to distribute a prize to a user.

### DETAILED DESCRIPTION OF ONE OR MORE EMBODIMENTS

The disclosure is particularly applicable to an internet and mobile technologies based secured lottery system and method as described and illustrated below and it is in this context that the system and method will be described. It will be appreciated, however, that the secured lottery system and method have greater utility since the system and method can be implemented using different technologies than those particularly disclosed.

Using the system and method described below, the need for travel to an authorized retailer is eliminated as a purchase can be facilitated anywhere, anytime via the Internet. This invention solves these problems by providing a computer user interface system from a mobile phone or from a computer to buy the lottery or keno ticket or play the game. In addition, using the system, winning tickets or games are automatically recognized and the purchaser is immediately notified and the winner will be notified in any of the electronics mechanisms: SMS or eMail or while playing. Furthermore, using the system and method, prize payments are made in accordance with state law and the prize money will be automatically distributed to the winner's account. The system and method employ a secured biometrics and signature verification system for age verification and login process that provides accountability for all the transactions in order to thwart any attempt to defraud the system. Now, various embodiments of the system and method are described in more detail.

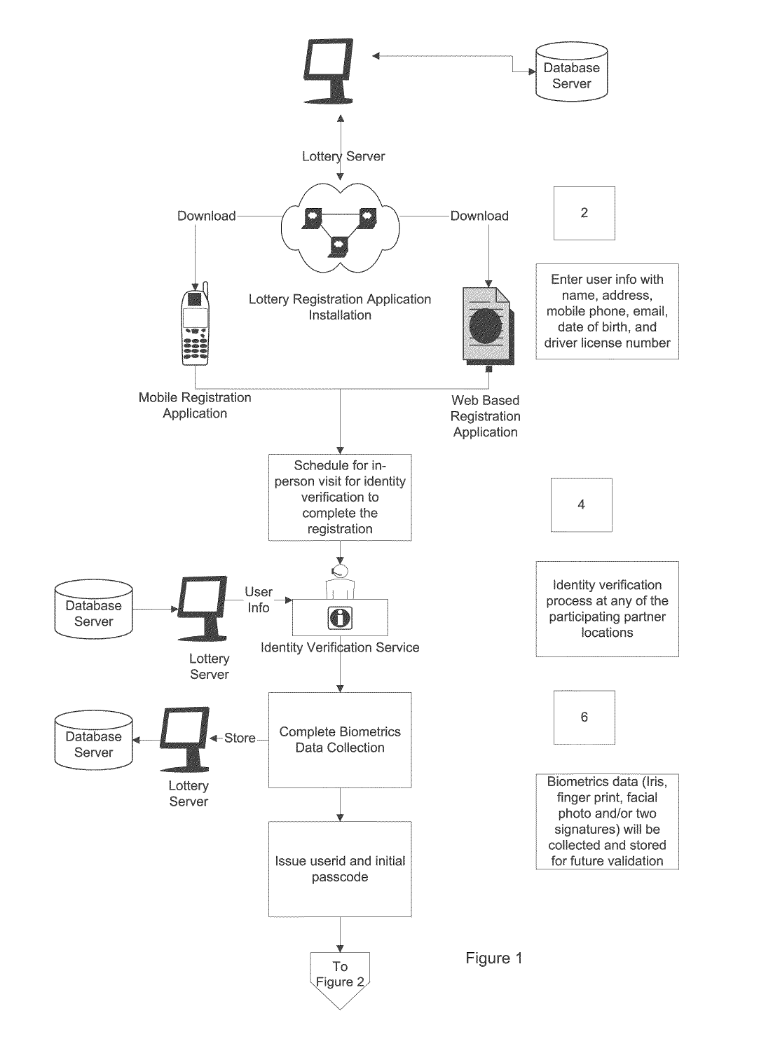

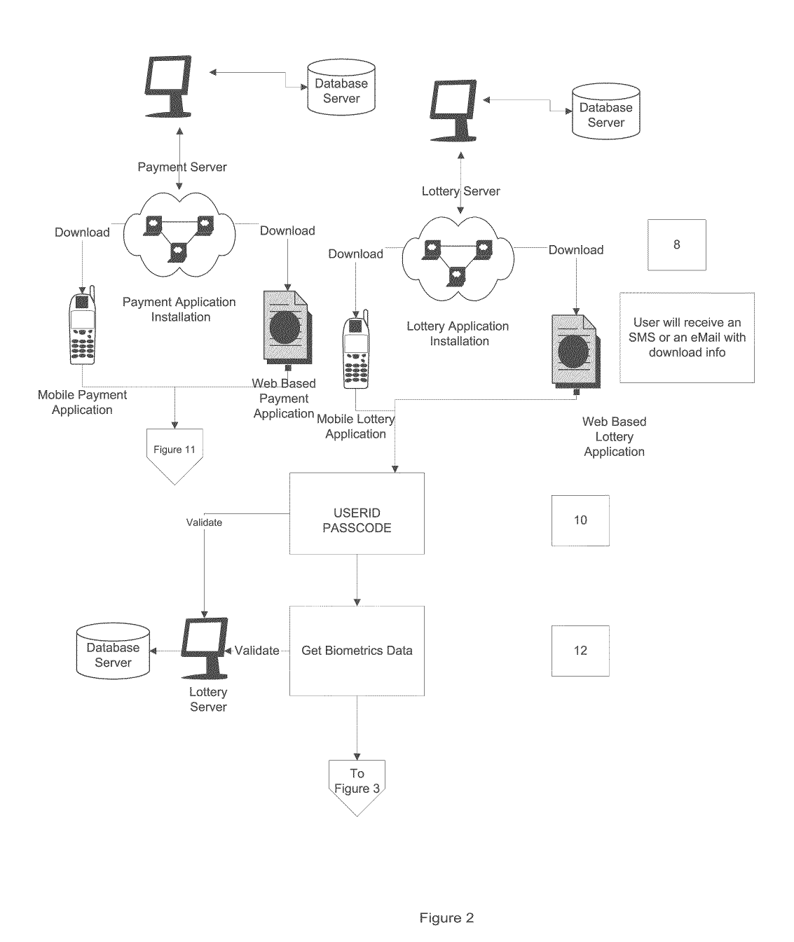

FIGS. 1 and 2 illustrate a first embodiment of a secured lottery system and method. The method may include a registration installation process 2, an identity verification process 4, a biometrics data collection process 6, an application installation process 8, a login process 10 and a biometrics verification process 12. In the figures described below, the hardware and software elements shown in the figures are linked/connected to each other in a wired or wireless manner using a link). For example, each user may use a computing device to interact with the lottery system (and the lottery server) wherein the computing device connects to the lottery system over a link.

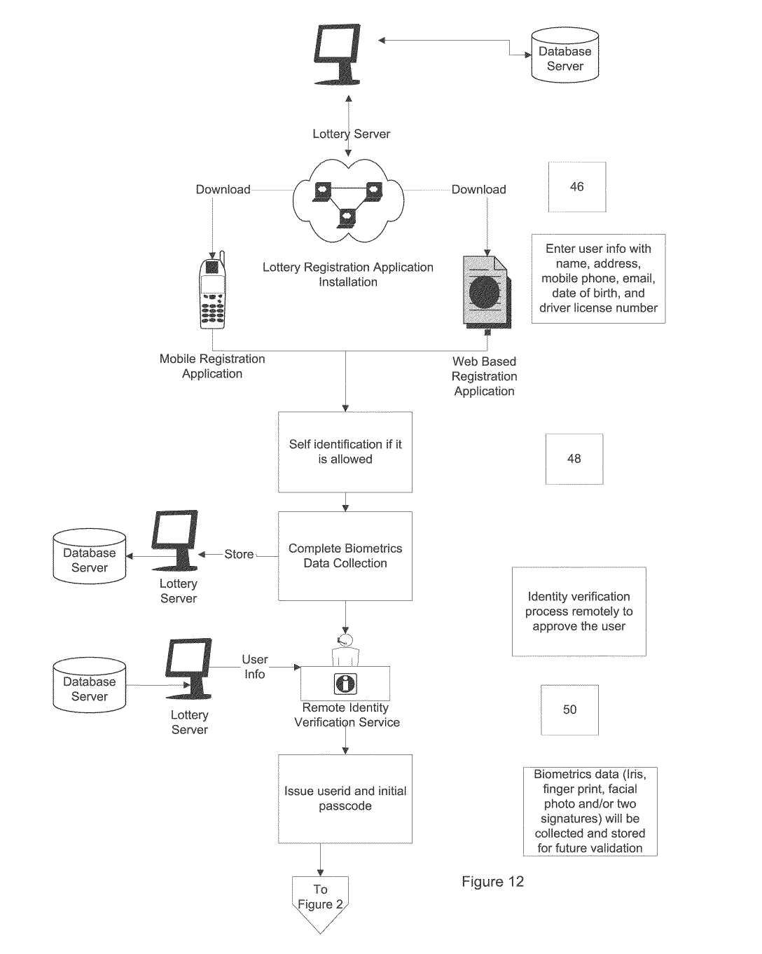

During Process 2, the purchaser needs to download the registration application by entering the web site location for the application. “Application” in this document refers to software and not a form or document completed by a purchaser of lottery tickets. Sample one is Error! Hyperlink reference not valid. As an alternative, Process 46 (shown in FIG. 12) may be allowed to use where self-identification mode is available. The alternate path will be determined by the respective lottery agency.

In Process 4, the purchaser has to go to one of the partners' physical location i.e. a state government office or authorized agent to provide identity verification. As an alternative, in Process 50, the purchaser's collected data will be verified remotely manually or automatically to approve the purchaser to play.

During process 6, at the same partner's location, the purchaser needs to give biometrics data to be stored. Biometric identification may utilize one or all of the following: a) Iris photos b) Fingerprint(s) c) Facial photo(s) d) Voice print(s) and e) Signature(s). As an alternative, in Process 48, the purchaser may be asked to provide all the necessary documents from the registration application without going to any of the physical locations. These self-collected data will be stored in the server to use them in the future purposes for login, profile change, to buy lottery or to play game, to receive winner's prize money etc.

In Process 8, the purchaser will either receive the lottery application link to download and install or at the biometrics collection center. Alternatively, the agent may install the application for the purchaser. The Process 10 requires the purchaser to login into the application by providing user id and passcode for identity. Both in mobile phones and web based applications, the initial default challenge will be the user id and passcode. The application may have multiple pages or single page depends on its capability and aesthetic look. The Process 12 will ask the purchaser to provide biometrics input to complete the authentication for the person's verification for age verification. This third challenge will be based on the biometrics device type attached to the device. The application agent will collect the information about the purchaser's device, and will deploy the appropriate biometrics authentication mechanism. For example, if a mobile phone has a camera, then the application will deploy either IRIS scan or facial scan.

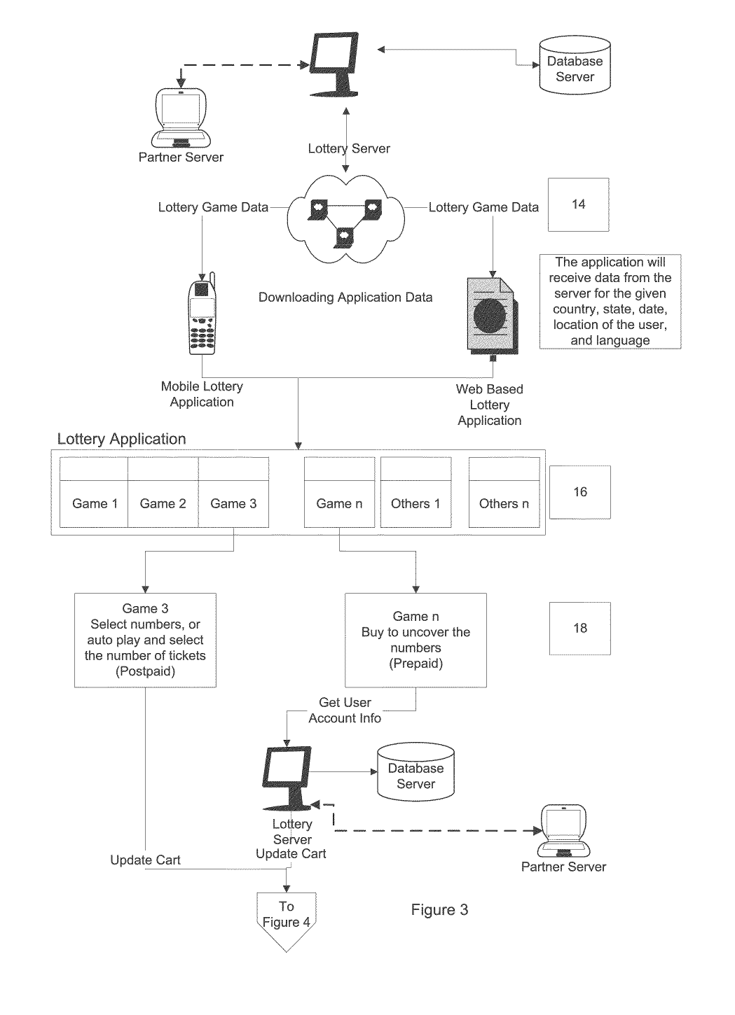

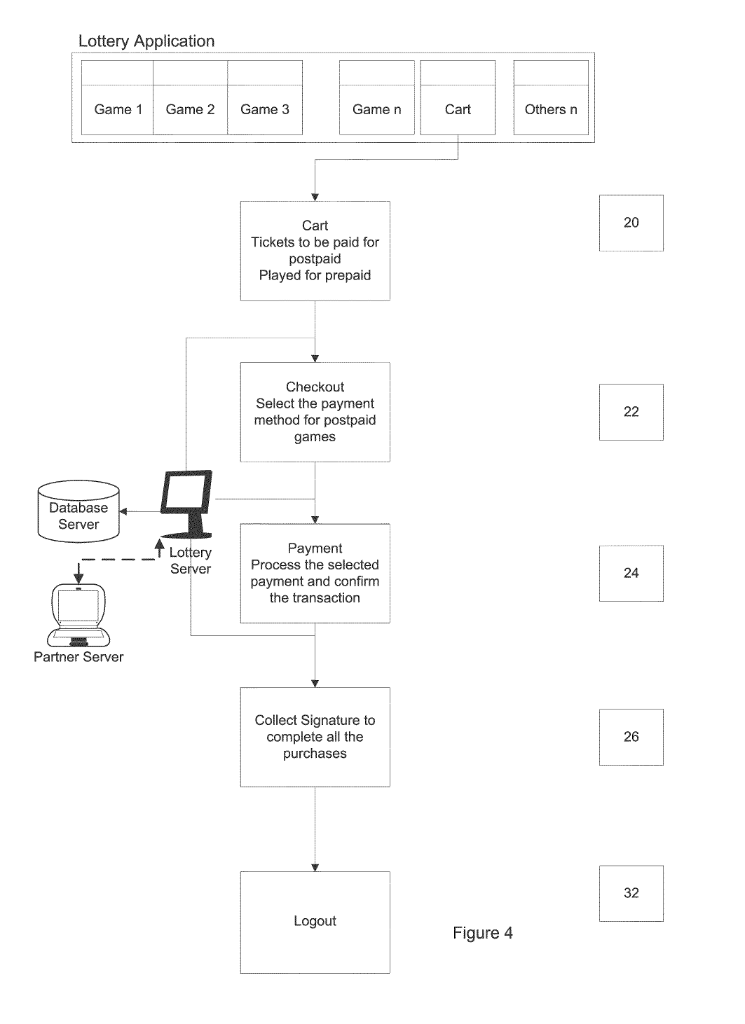

FIGS. 3 and 4 illustrate another embodiment of the secured lottery system and method in which the user can play lottery games. The method may include a server data fetch process 14, a games display process 16, a playing games process 18, a cart contents process 20, a checkout process 22, a payment presentation process 24, a completion with biometrics signature process 26, a receiving winner notification process 26, a receiving winner notification process 28, a viewing prize distribution process 30 and a logout process 32.

In Process 14, the lottery application downloads the data to build the necessary presentation to the purchaser to play the games/lotteries with other pertinent data to support each game. With Process 16, the purchaser can choose the game to play. The Process 18 allows the purchaser to play the game by displaying the rules or valid times to play and prize money for the game.

The Process 20, the application shows all the lottery games played but not yet paid for postpaid games and all the lottery games played and complete for prepaid games. In Process 22, the purchaser can do checkout to pay for the post-selection-paid games wherein post-selection-paid games are the games where the purchaser has to choose the choose the numbers first before paying. The Process 24 displays the payment options to choose to make the payment for the games. In Process 26, as part the games that the purchaser played in this current session, the purchaser may need to use one of the biometrics procedures to complete the purchase. The lottery agency or its lottery vendor will decide what kind of security feature to be included as part of the purchase completion.

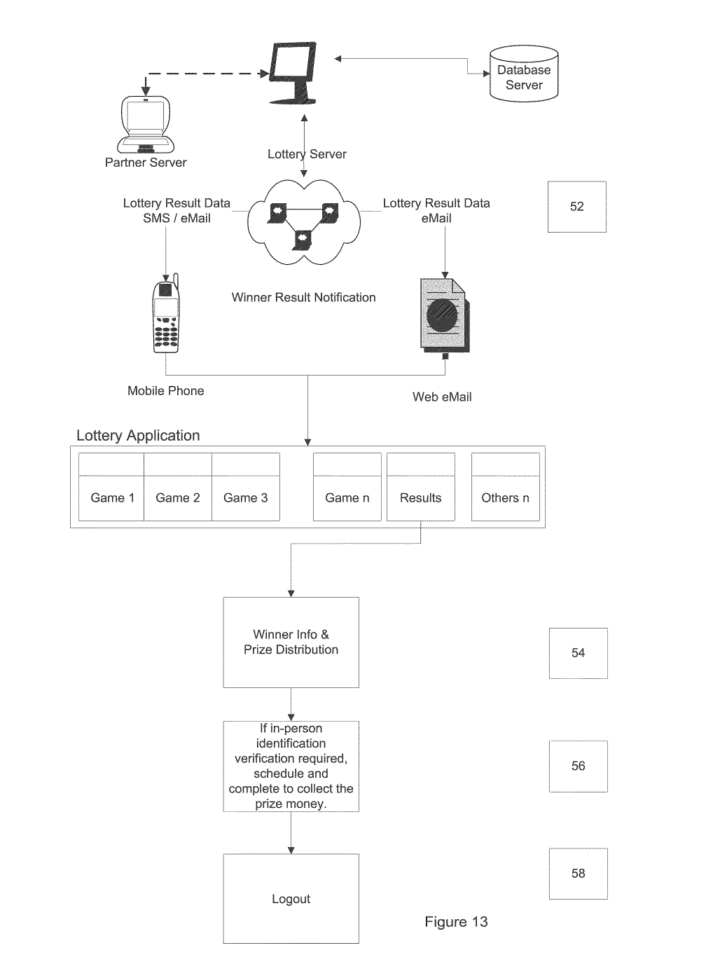

In Process 28, the winner will get the notification if only if the purchaser is the winner. In the setup option, the purchaser can choose to receive notification even if he/she is not a winner. As an alternative in self-identification mode, a conditional but similar notification will be sent in Process 54 as shown in FIG. 13. The notification may differ if there is a need for the winner needs to go the lottery agency office to verify the identification. Process 56 may be required if the lottery agency determines that the winner-purchaser's identification needs to be verified in-person. With Process 30, the purchaser can go into the application to check for which game, how much the prize is and in which account the funds were deposited. The Process 32 is the logout process from the application to exit completely. The lottery application determines the jurisdiction, collects the allowed games within that jurisdiction, language, user preference, date and time to determine which games are allowed to play, determines whether the games is pre-paid or post-paid, and devices' capabilities to support those games. In general, in many situations, buying lottery tickets are post-paid as the purchases first needs to choose the tickets to buy, whereas playing games in single-user or multi-user are pre-paid. When the purchaser needs to make the payment, based on the lottery agency's requirement, the payment application may collect more biometrics data from the purchaser to complete the transaction to make sure he/she initiated the activity and authorized it. For example, in a smart phone, it may collect signature from the touch pad if it supports handwriting or if it supports voice recording, then a voice data will be collected.

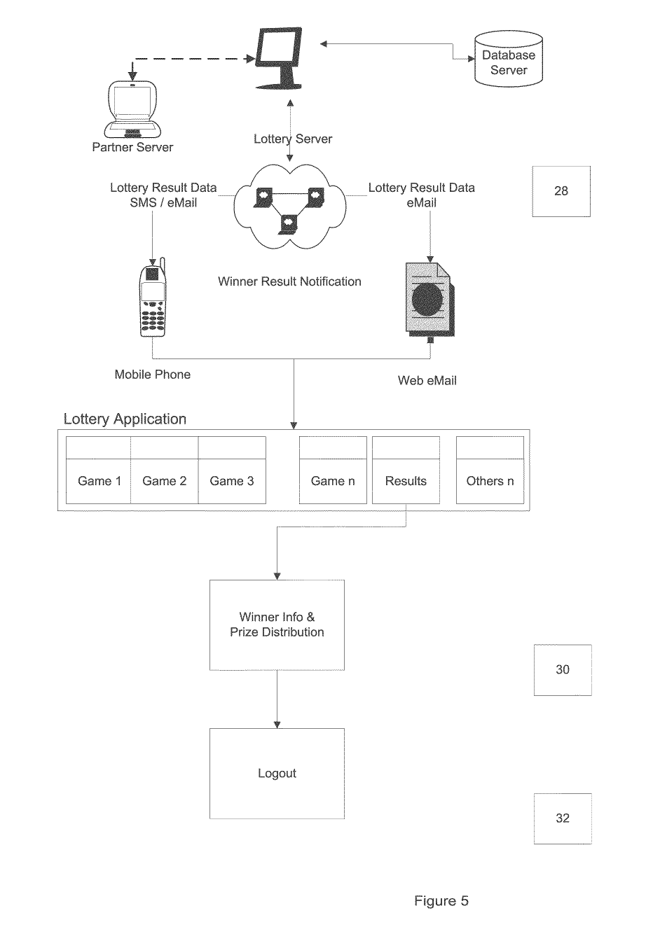

FIG. 5 illustrates the secured lottery system and method being used to distribute a prize to a user. The method may include a receiving winner notification process 28, a viewing prize distribution process 30 and a logout process 32. In Process 28, the winner will get the notification if only if the purchaser is the winner. In the setup option, the purchaser can choose to receive notification even if he/she is not a winner. As an alternative in self-identification mode, a conditional but similar notification will be sent in Process 54 as shown in FIG. 13. The notification may differ if there is a need for the winner needs to go the lottery agency office to verify the identification. Process 56 may be required if the lottery agency determines that the winner-purchaser's identification needs to be verified in-person. With Process 30, the purchaser can go into the application to check for which game, how much the prize is and in which account the funds were deposited. The Process 32 is the logout process from the application to exit completely. If a mobile phone is the main device of choice for the purchaser, an SMS message will be sent as a notification. If a computer is the main device of choice, then email will be sent with the winner notification. The purchaser has to login to the application to see the complete details of the notification. If the purchaser has completed all necessary steps in clearing his/her identification and other tax related information, then he/she may a final choice to where to transfer the funds. If the purchaser has elected already where to receive the funds, it might have happened if there are no conditions attached to it. Otherwise, the application will guide him/her to complete the lottery agency requirements before transferring the winning money.

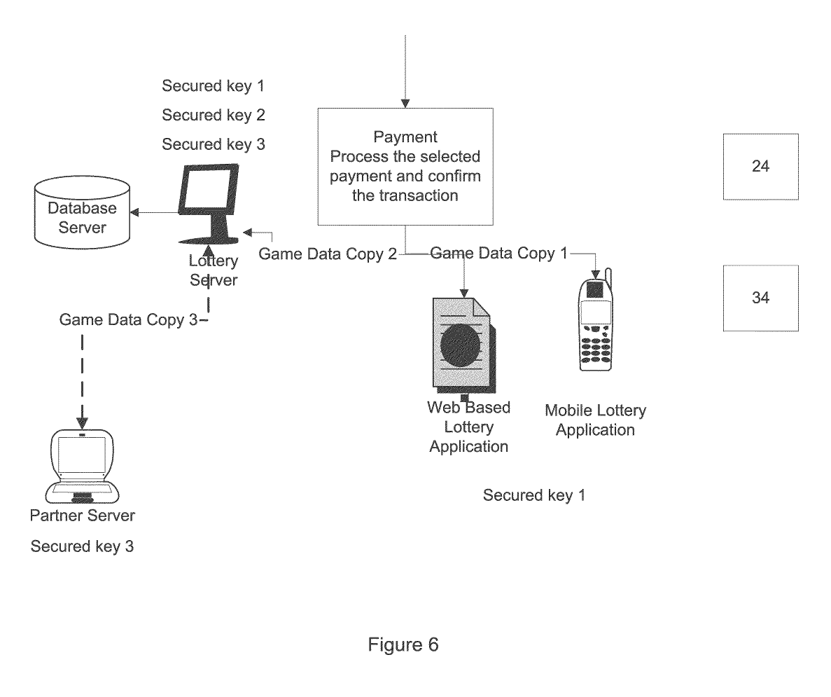

FIG. 6 illustrates the secured lottery system and method being used to store a game. The method may include a payment presentation process 24 and a storing the played games process. The process 34 shows where the previously played games get stored and how the security keys protect the data. For example, if the purchaser buys some lottery tickets which are worth $20 with each ticket costing $1 to buy. The 20 tickets' information plus the purchase details will be first encrypted with secured key 1, which is the purchaser's key. This encrypted date will be sent to the lottery server, where it gets again encrypted with secured key 2, which is the lottery server generated key, and then this already twice encrypted data will be encrypted with the secured key 3, which is the lottery agency's or its systems partner's generated key. The lottery agency has the option about the secured key 3; where to be created, that is whether it will be allowed to be created by the lottery server on behalf of the lottery agency and its systems partner or by the lottery agency or its systems partner's server, and where to be stored; whether to store it at the lottery server or at the lottery agency or its systems partner's server. To open the data file successfully, the lottery server needs all the keys to display the actual contents. The purchaser will be given the option where to save the data and the key; it can be in the device it self or a remote secured data storage system that he/she can manage. This remote secured data storage may be provided by the lottery service provider or by a third party data storage service provider.

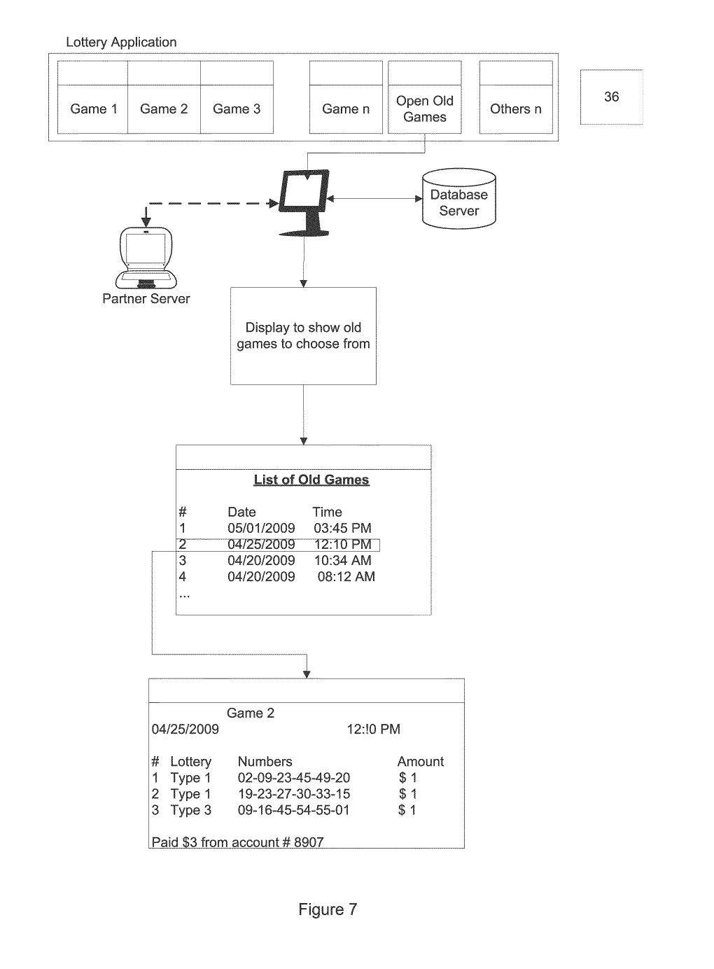

FIG. 7 illustrates the secured lottery system and method being used to view stored games. The method may include a retrieving the previously played games process 36. With process 36, the application shows how it receives the previously played games. The purchaser may wish to see the old tickets that he/she bought previously or the games played and his/her status. It may help him/her for reference to strategize on how to buy or play those tickets and games in the future. It may have details on winning as well if he/she had own previously.

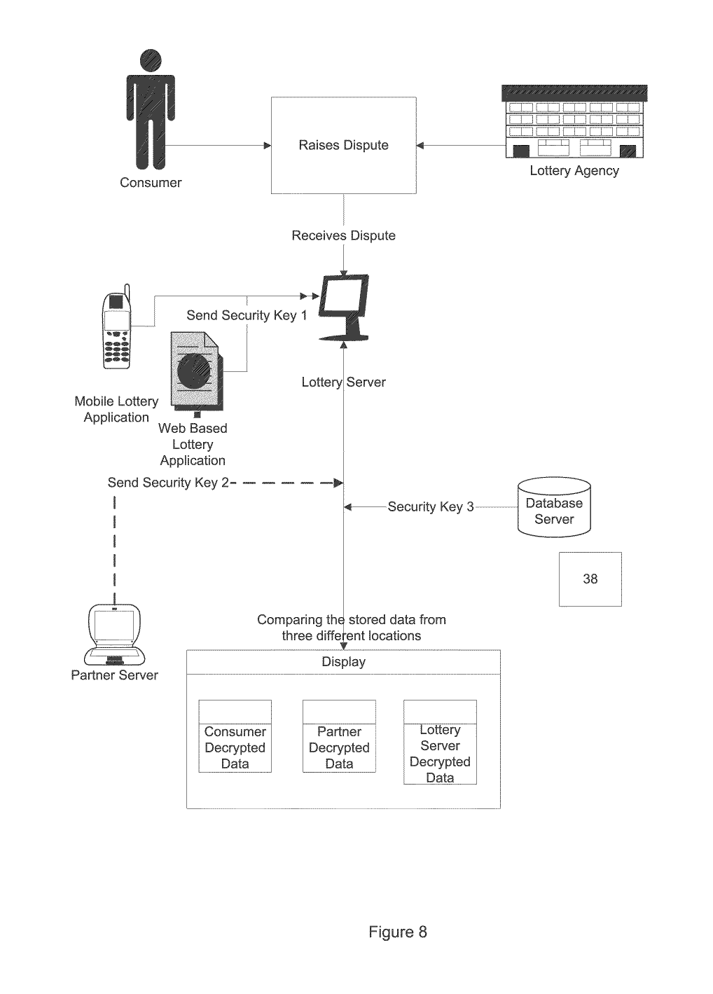

FIG. 8 illustrates the secured lottery system and method being used to resolve a dispute that has a comparing the stored data for any disputes process 38. In process 38, the process shows how it resolves any disputes between a purchaser and the lottery agency. Sometimes, the purchaser wants to check the validity of the whole process or a part of it for various reasons including that he/she believed that he/she bought tickets or played games that he/she won. Not only that, he/she may want to find out whether the tickets and the games got really included in the lottery gaming process. Whatever be the reason, the purchaser raises a dispute ticket. The case comes to the server. Depends on the setup in the configuration created and determined by the lottery server and the lottery agency, the dispute resolution may be done on automatic workflow path to solve it or manual process may be set in place to handle it or a combination of both. In all these three cases, the lottery server will collect the three data files stored at three different locations and also the three different keys; one from the purchaser, another one from the lottery server and the last one from the lottery agency or its systems partner server. The lottery server decrypts all these data files with all these three encrypted keys in the reverse order to get the clear text file, and displays the contents. If there is no difference whatsoever, the dispute is considered resolved. If there is any difference anywhere, then a manual intervention takes place to handle it. During the manual process, if the difference is due to any sort of changes in the purchaser's data, then only the data stored in the lottery server and the lottery agency or its system partner's server data will be used with all the three keys to compare.

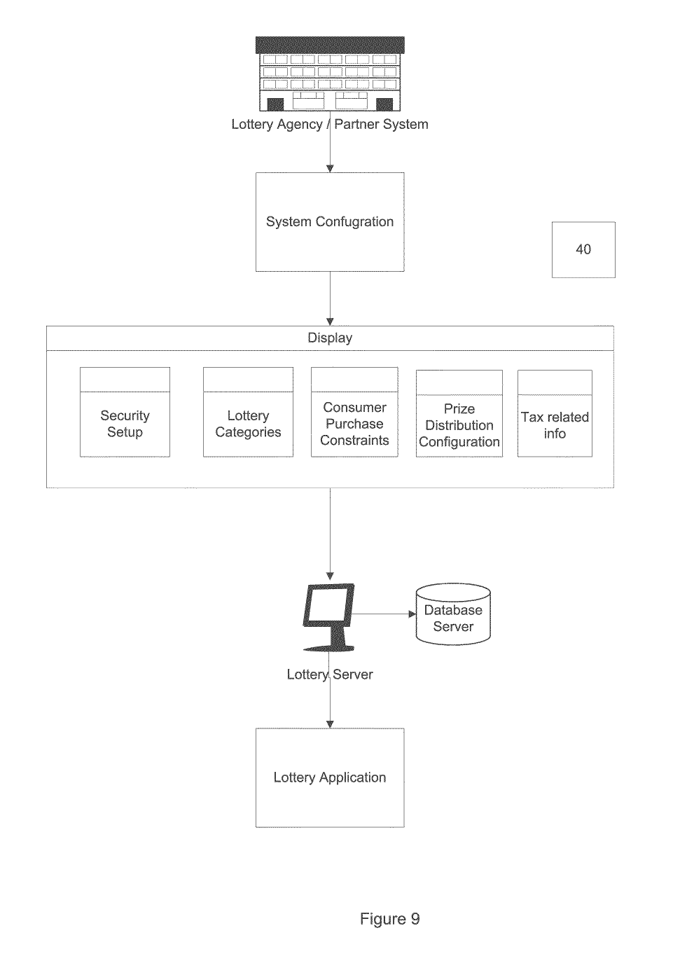

FIG. 9 illustrates an example of the system configuration of the secured lottery system and method that may include a system configuration process 40. The process 40 shows the system configuration to be set for each country or state or any setup like purchase limitation, languages to be used, which games are allowed to play, sale boundary, state, federal and/or local taxes to be withheld on winning and any other constraints need to be included. The type of data is in table format to show the characteristics of the configuration created by the lottery agency for its constituents. Lottery Category table will have country and/or state to identify the lotteries available, and new lottery category can be created or an existing one can retired or temporarily stopped. It will have details about what frequency that it will be drawn, prize money with different combination of matching numbers, cost of the ticket, start date and time, drawing data and time etc. The Security Setup table will include information like what information to collect from the purchaser at what point; during the registration and at the time of purchase and at the time of winning etc. It also has information about the kind of allowed biometrics data and when to use. Once these system configuration is setup, when the purchaser logs in, and based on his/her location, the specific configuration will be applied to control the overall purchasing the tickets or playing the games. For example, under the purchase limitations, the lottery system may set a lottery game purchase limit for a particular user or for all lottery games based on various criteria, such as income or income bracket of a user, generic job classification of a user or a job classification in an address of the user. As another example, for each lottery game in a particular region, the system, before allowing a user to purchase the lottery game, confirms the user's presence in a particular boundary/region of the lottery game based on a combination of connected device's data, an agent's data in the connected device, and/or the server's data about the connected device wherein the connected device is the computing device that is used by the user to interact with the lottery system. The computing device may be a processing unit based device with memory and connectivity so that the computing device can interact with the lottery system as described above. For example, the computing device may be a personal computer, a tablet computer, a mobile phone, a smartphone, etc. . . .

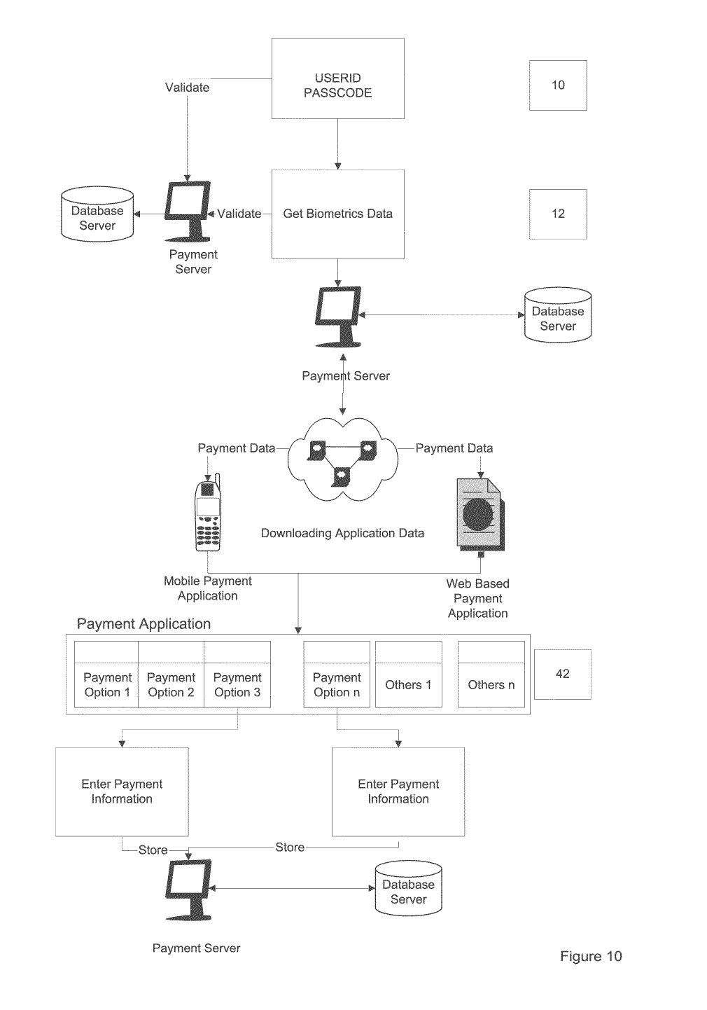

FIG. 10 illustrates the secured lottery system and method being used to secured process a payment in which the method may include the login process 10 and the biometrics verification process 12 as described above as well as a payment application process 42. The payment application process 42 can be a separate application or part of the lottery application. In process 42, the purchaser downloads the payment application to enter the payment instruments to be used later when he/she buys the lottery games. For example, Payment Option 1 may be from a bank checking account, and Payment Option 2 may be a credit card account. Even one payment option may be equivalent to cash for the cash or check deposits made into the account. The account types that are allowed to operate depend on each lottery agency's jurisdiction. In the payment application, the purchaser may have many payment instruments, but during the usage of it for the purchase of the lottery tickets or games will be restricted to the payment instruments that are allowed by the lottery agency.

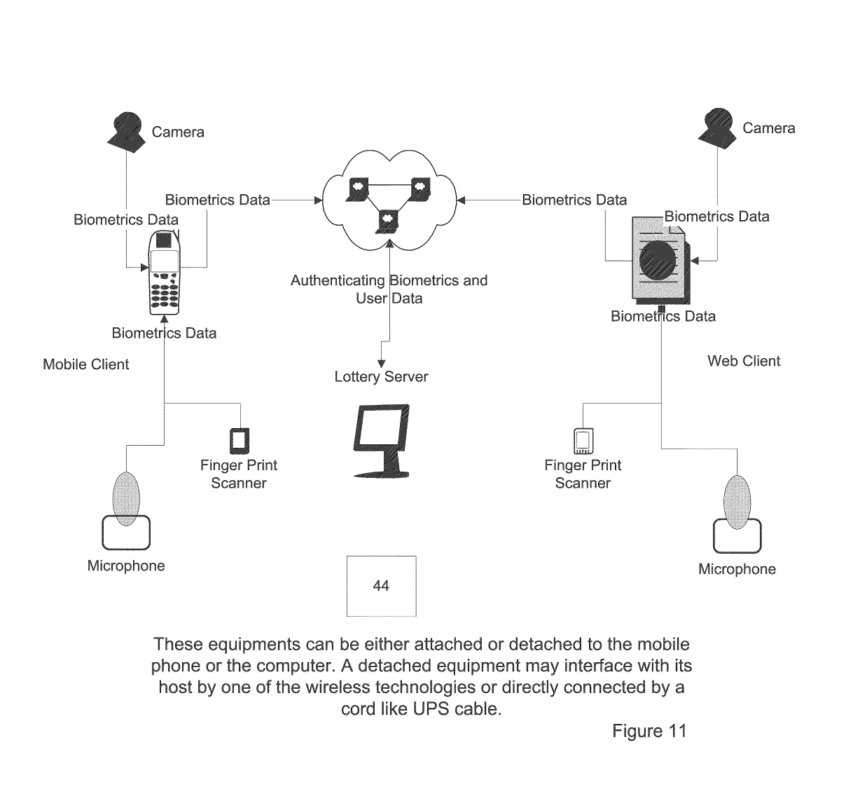

FIG. 11 illustrates details of the security of the secured lottery system and method in which the method may include a security equipment usage scenarios 44 which are the possible ways the security system interface between the client and the server for authentication. If the purchaser's device has camera, microphone and/or finger print scanner, based on the biometrics data allowed to collect, and in the order it should be collected, which are all set during the system configuration by the lottery agency, the lottery server forces the device to collect those data. For example, if the device has all the three input devices; camera, microphone and finger print scanner, but the lottery agency's setup allows only to collect facial scan and voice print, the finger print scanning will be not deployed in that jurisdiction. During the facial scan, the lottery biometrics data collection module will open the camera, and will give the information to the user when to start and end the recording of the facial scan. During the process, it may collect the entire recording of the video with randomized snap shots or just a snap shot. This collected data will be sent to the server for storage, verification process, and login in the future to use the application. This first time facial scan image will be stored in the server after a quality assurance test. When the purchaser logs in the next time, a new facial scan snap shot will be taken, and will be compared with the one already stored. If this comparison falls within the range of certain threshold value, then the purchaser is allowed to get into the application successfully.

FIG. 13 illustrates an alternative way that the secured lottery system and method can be used to distribute a prize to a user in which a process 52 of identification is used instead of the self-identification process 28 in FIG. 5. Furthermore, a process 54 winner information and distribution is used as an alternative to the process 30 shown in FIG. 5. In addition, a logout process 58 as an alternative to the logout in self-identification mode.

Relationship Between the Steps or Elements

The processes 2, 4 and 8 are grouped together for the purpose of registration, identity verification and biometrics data collection for authentication purposes. Completing these steps will allow the purchaser to access the lottery application and its lottery games. In process 2, the purchaser gets registration part of the application to create his/her profile. With that profile, the purchaser visits one of the listed locations to provide the identification, proof of age, and biometrics data. The processes 46, 48 and 50 are alternate paths for the same registration process, but in self-identification mode as shown in FIG. 12. The lottery agency can decide what to collect during this registration process, and postpone the a part of it until the purchaser wins the lottery or the game.

The processes 10, 12, 14, 16, 18, 20, 22, 24, 26 and 30 are grouped together to show how the lottery application works. It also shows the login and biometrics authentication process. Alternative process for 30 is shown in process 54 in self-identification mode in FIG. 13 with different content if there is any additional in-person identification requirement to be met. If so, process 56 will be executed.

The process 28 shows SMS/eMail communication between the purchaser and the lottery server. A similar communication step is shown in process 52 in FIG. 13 as an alternative to process 28 for self-identification mode. It checks for any additional requirement to be met before the prize money can be distributed.

The process 32 is a common step all the groups to logout of the application. The processes 34 and 36 are to show on how the purchaser played data is being stored, and is being retrieved for later reference. The process 38 depicts the scenario of dispute resolution and process 40 shows the flow of the configuration setups from the lottery agency or lottery vendor system to lottery server to the lottery application. The Step 42 collects the payment information from the purchaser and feeds that payment information to the lottery application so that the purchaser can complete purchasing the lottery games. The purchaser can make changes to the payment information in the payment application, which is reflected in the lottery application.

System Operation

In Process 2, the purchaser downloads the registration application to register to provide personal data including, but not limited to depending on each state's regulations name, address, driver license number, SSN, date of birth, email, mobile number etc., which will create a user profile. Upon receiving these inputs from the purchaser, the lottery server will give the purchaser a list of locations to go to for identity verification and biometrics and/or photo data collection. This verification and data collection requirements will be defined by Process 40, which is the system configuration setups. The lottery agency or the lottery vendor who run the lottery system will define these in accord with each state's laws. The data collection part completes the registration process, and an initial user ID and passcode will be provided to the purchaser to use with the lottery application. The location may be a state government office, or a private agency approved by the government to collect them. Upon completing the registration, the lottery server sends out a message in through SMS or by eMail to download the required applications, lottery application and payment application. Both these applications will have the same user interface to login. By using either one of the applications, the purchaser needs to change the initial passcode provided at the biometrics data collection location. Now, the login screen will appear again to take the new passcode, and based on the system configuration from Process 40, the purchaser will be challenged with one or more biometrics identifications. For example, if the biometrics requirement is set to collect iris scan, then the purchaser needs to scan his/her eye to get authenticated. Once the identification is established, the application appears. In case if the purchaser's payment options are not set yet, the lottery application will remind him/her to complete the Process 42 to enter the payment instrument information to make the necessary payments to purchase the lottery games. If the payment options are already set, then the lottery application receives all the necessary data, it displays all the lottery games, and other supporting options to choose from.

As part of the Process 40, the lottery agency may decide to configure the lottery system to self-identification mode. The whole process of logging in, buying or playing, making payment, and receiving prize money will be the same as above except that during the registration process, the lottery agency may choose self-identification mode. Or they can choose to collect those data in-person once the purchase wins either a lottery or a game or a combination of both wherein with self-identification during the registration process, and in-person identification verification upon winning either the very first time for any amount or for a certain amount or above.

Again, the Process 40 defines the lottery games available in the lottery application. The lottery server periodically gets update from the lottery agency server or the lottery vendor server about the changes, updates, results, and maintenance related data etc. Now, the purchaser can start playing the lottery games. Based on the games the purchaser chooses, whether pre-payment is necessary or not will be determined. When the payment options are created, at least one must be linked for pre-selection-paid games (which are games where the purchaser has to pay not knowing what he/she is going to get; the numbers or any other objects like images. For example, in playing scratchers, the purchaser can not see the hidden numbers or images until he/she pays to uncover it.) For post-selection-paid games described above and fixed-selection-paid games (games where the purchaser can see what he/she is going to buy, but can not change the printed data. In some state or country lotteries, the lottery tickets will have pre-printed numbers or images. In this game, the maximum prize winner will be only one), based on the rules of the games including restrictions on how many games to play as per the configuration, he/she will play the games, and they will be saved in the shopping cart. Once the games are completed, the purchaser can check the shopping cart before purchasing. The cart will show the lottery category, the amount to be paid, date of draw etc. When the purchaser chooses check out, the check out window will show the payment options, and the total amount to be paid. Once the amount is paid, based on the system configuration, biometrics data collection will done and the game data will be saved with this biometrics data in three different places all in encrypted format: one at the purchaser system, the second one at the lottery server, and the final one at the lottery agency or the lottery vendor system. Each of this is a duplicate copy of the other one, requires a minimum of two or three security keys to decrypt. One of the keys will be created by the purchaser, and the other two keys will be created by the lottery server to represent the lottery server and the lottery agency/lottery vendor systems respectively. In the event of any disputes, all these parties need to enter their encryption keys to decrypt these data files to retrieve the data to compare. When a purchaser wins a prize, he/she will receive a message in SMS or eMail format. Upon logging into the application, the purchaser can check the prize money for which game, and the draw date. As per the lottery agency setup and based on the prize money won, the money will moved to the predefined account or accounts, which are entered in payment application, which is Process 42.

In the above figures, for each actual implementation of the system and method, each process may or may not be used for any particular actual implementation which will be determined during the configuration process 40 described above. The advantage of using the payment application, for example, as an independent application is to use it with any other services that would depend on the payment information. For example, the independent payment application can be used to distribute unemployment benefits, any other government monetary help, or even individual-to-individual financial transactions.

Since the lottery systems in different regions (states and/or countries) vary, the following different combinations can be used to make the system and method described above work in different scenarios. For example, for a given country, each state might have a specific set of lottery games, and they might support a few languages, and within the lottery category, there will be ways to play; either pre-printed or purchaser to choose the numbers or equivalent to it. Thus, the system can be configured by:
1) Country
2) State
3) Language
4) Lottery category
   a) Consumer selectable numbers
   b) Preprinted numbers
   c) Preprinted images
   d) Any other objects which are presentable

In playing games too, different countries and states can prefer games that reflect their culture and language. When one agency may prefer to single user games, some other agency may prefer multi user games.

The system and method described above for a lottery also can be used in similar applications like banking systems and voting systems where higher-level security standards, accountability of the purchaser and system transactions, and verification of those transactions are necessary. Furthermore, the secured system may be used with an electronic government (eGovernment) service in which a government agency has a service, such as the lottery, that uses the above secured system.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A method for using biometrics to complete the signing the lottery ticket, the method comprising:
downloading, to a computer of a user, a lottery application;
collecting biometric data from the user; and
authenticating a user that wants to purchase a lottery ticket using the collected biometric data.

2. The method of claim 1, wherein collecting the biometric data further comprises collecting the biometric data of the user at an identity verification office.

3. The method of claim 2, wherein collecting the biometric data further comprises collecting the biometric data of the user by the user and verifying the collected biometric data by a remote identity verification office.

4. The method of claim 1, wherein downloading the lottery application further comprises entering user information that is stored in the lottery system wherein the user information include an address of the user; and further comprising storing a set of lottery data for each region in which a lottery is present, the set of lottery data including a set of lottery games for a particular region and displaying a set of lottery games to the user based on the address of the user.

5. The method of claim 1 further comprising automatically notifying, by a lottery system, a user when the user won a prize at a lottery game and automatically distributing, from the lottery system, the prize to the user.

6. The method of claim 1 further comprising setting a purchase limit for a lottery game.

7. The method of claim 6, wherein setting the purchase limit further comprises setting the purchase limit based on one or more of an income of a user, an income bracket of a user, a generic job classification of a user and a job classification for a particular location.

8. The method of claim 1 further comprising resolving disputes by comparing a data file of consumer data, a file of partner and a file of a lottery server.

9. The method of claim 4 further comprising confirming a user's presence in a region of a particular lottery game before the particular lottery game is downloaded to the user.

10. The method of claim 9, wherein confirming a user's presence in a region of a particular lottery game further comprises verifying a location of a computing device being used by the user to download the lottery game.

11. A system for using biometrics to complete the signing the lottery ticket, the method comprising:
a lottery system
one or more computing devices that are capable of connecting to the lottery system over a link, each computing device allowing a user to interact with the lottery system;
wherein the lottery system downloads a lottery application to the computing device of a particular user; collects biometric data from the user and authenticates a user that wants to purchase a lottery ticket using the collected biometric data.

12. The system of claim 11, wherein the lottery system collects the biometric data of the user at an identity verification office associated with the lottery system.

13. The system of claim 11, wherein the lottery system collects the biometric data of the user by the user and the lottery system verifies the collected biometric data by a remote identity verification office associated with the lottery system.

14. The system of claim 11, wherein the lottery system stores user information wherein the user information include an address of the user and wherein the lottery system stores a set of lottery data for each region in which a lottery is present, the set of lottery data including a set of lottery games for a particular region and displays a set of lottery games to the user based on the address of the user.

15. The system of claim 11, wherein the lottery system automatically notifies a user when the user won a prize at a lottery game and automatically distributes the prize to the user.

16. The system of claim 11, wherein the lottery system sets a purchase limit for a lottery game.

17. The system of claim 16, wherein the lottery system sets a purchase limit for a lottery game based on one or more of an income of a user, an income bracket of a user, a generic job classification of a user and a job classification for a particular location.

18. The system of claim 11, wherein the lottery system resolves disputes by comparing a data file of consumer data, a file of partner and a file of a lottery server.

19. The system of claim 14, wherein the lottery system confirms a user's presence in a region of a particular lottery game before the particular lottery game is downloaded to the user.

20. The system of claim 19, wherein the lottery system verifies a location of a computing device being used by the user to download the lottery game.

21. The system of claim 11, wherein each computing device further comprises one of a personal computer, a tablet computer, a mobile phone and a smartphone.

22. A system for using biometrics to complete the signing the lottery ticket, the method comprising:
an electronic government system;
one or more computing devices that are capable of connecting to the electronic government system over a link, each computing device allowing a user to interact with the electronic government system;
wherein the electronic government system downloads an electronic government application to the computing device of a particular user; collects biometric data from the user and authenticates a user that wants to purchase a lottery ticket using the collected biometric data.

23. The system of claim 22, wherein the electronic government application is a lottery application and the electronic government system is a lottery system.
